(19) United States
(12) Patent Application Publication
(10) Pub. No.: US 2022/0024010 A1
(43) Pub. Date: Jan. 27, 2022

(54) TOOL FOR PIPE EXTRACTING

(71) Applicant: Brian Kashima, Makawao, HI (US)

(72) Inventor: Brian Kashima, Makawao, HI (US)

(21) Appl. No.: 16/936,971

(22) Filed: Jul. 23, 2020

(51) Int. Cl. B25B 27/18; B25B 23/00; B25G 1/08

(52) U.S. Cl. CPC B25B 27/18; B25G 1/085; B25B 23/0028; B25B 23/0035

(57) ABSTRACT

A device comprises a body with two opposed spaced apart side walls, each side wall having a first end and a second end, with a slot between the side walls. A first holder is mounted between the side walls proximate the first ends and likewise a second holder is mounted between the side walls proximate to the second ends. The holders can pivot at least 270 degrees, and preferably completely rotate, on an axis perpendicual to the planes of the side walls. A first mount is supported by the first holder for removably mounting a first tool on the first holder, and a second mount is supported by the second holder for removably mounting a second tool on the second holder.

### CROSS-REFERENCE TO RELATED APPLICATIONS

This application is related to U.S. Design Patent Application Ser. No. 29/738,420, filed Jun. 17, 2020, which is incorporated herein by reference.

### BACKGROUND

Pipe extractors can be used for extracting a broken pipe such as a pipe broken off inside fittings. A typical extractor is a single piece having a head section for placement into the broken pipe and an opposed end section which can be gripped by a wrench for turning. In use the extractor is placed into the piece of broken pipe, and then turned counterclockwise to unscrew the broken pipe from the fitting.

A problem with many such extractors is access to the broken pipe. Generally, extractors need to be axially aligned with the axis of the pipe and in some situations, there is insufficient space to use the extractor. Moreover, professionals work on different sized pipes, and thus for them it is necessary to carry multiple different extractors.

### SUMMARY

The present invention is directed to a solution to the problems with conventional extractors. In particular a device having features of the present invention comprises a body formed of two opposed spaced apart side walls, each side wall having a first end and a second end. There is a slot between the side walls. A first holder is mounted between the side walls proximate the first ends and likewise a second holder is mounted between the side walls proximate to the second ends. The holders can pivot at least 270 degrees, and preferably completely rotate, on an axis perpendicular to the planes of the side walls. A first mount is supported by the first holder for removably mounting a first tool on the first holder, and a second mount is supported by the second holder for removably mounting a second tool on the second holder. In a preferred version of the invention the tools are pipe extractors of different size. The slot is sufficiently large that a tool can be mounted on each mount with the tools being at least partially in the slot.

Preferably there is a recess in an exterior surface of at least one of the side walls for holding an implement.

An example of a mount is a pin extending from the respective holder, where the tool has a corresponding opening to removably fit on the pin. By “removable” or “removably” there is meant that a typical user can remove the tool by hand.

The device can be used with tools other than extractors.

### DRAWINGS

These and other features, aspects and the advantages of the present invention will become better understood with regard to the following description and claims, and the accompanying drawings, where:

FIGS. 1 and 2 are perspective views of a device having features of the present invention.

FIGS. 3 and 4 are side elevation views of the device of FIG. 1;

FIG. 5 is a front elevation view of the device of FIG. 1;

FIG. 6 is a rear elevation of the device of FIG. 1;

FIG. 7 is a top plan view of the device of FIG. 1;

FIG. 8 is a bottom plan view of the device of FIG. 1;

FIG. 9 is a perspective view of the device of FIG. 1 with an extractor tool pivoted to a working position;

FIGS. 10 and 11 are side elevation views of the device as shown in FIG. 9;

FIG. 12 is a front elevation view of the device as shown in FIG. 9;

FIG. 13 is a rear elevation view of the device as shown in FIG. 9;

FIG. 14 shows the device as shown in FIG. 9 showing an extractor in phantom and showing how it pivots;

FIG. 15 is a perspective view of a device according to the present invention with extractor tools in a storage position;

FIG. 16 is a perspective view of a device according to the present invention having two extractors and showing various positions of the extractors in working positions;

FIG. 17 is an exploded perspective view of the device shown in FIG. 9 including auxiliary implements to be stored in the side walls of the device;

FIG. 18 is an exploded perspective view of portions of the device shown in FIG. 9;

FIGS. 19-20 are sectional views of the device of Fig, 9 taken on lines 19-19 and 20- 20, respectively, of FIG. 13; and

FIGS. 21 and 22 are sectional views of the device of FIG. 9 taken on line 21-21 of FIG.

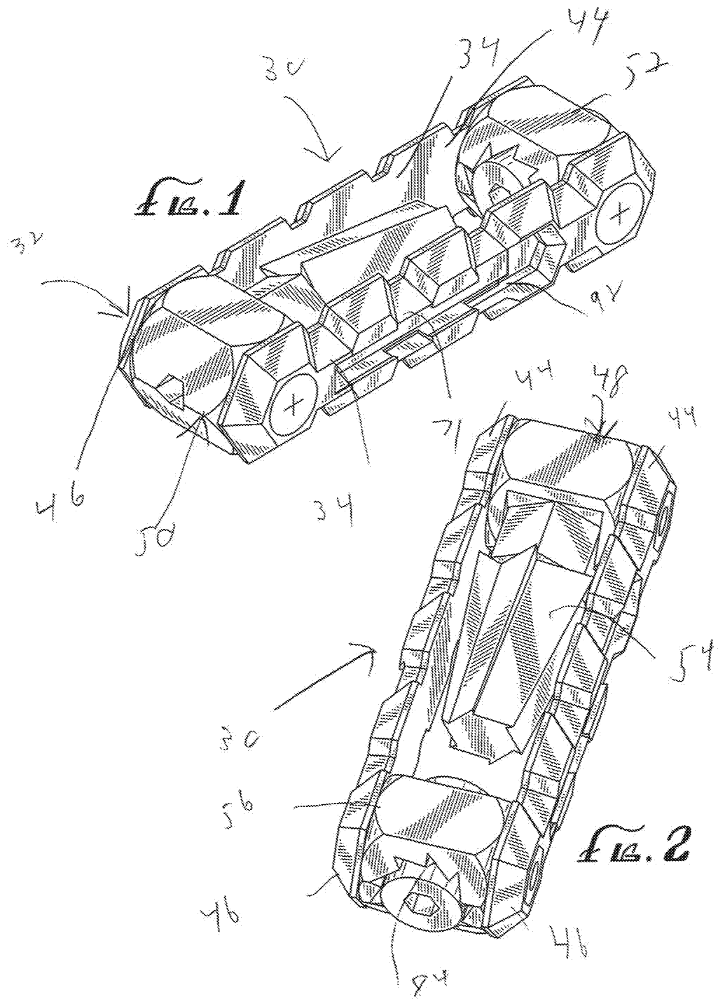

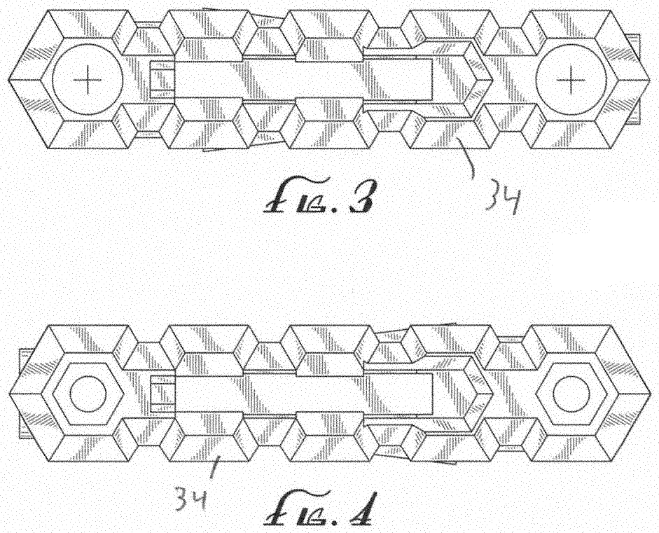

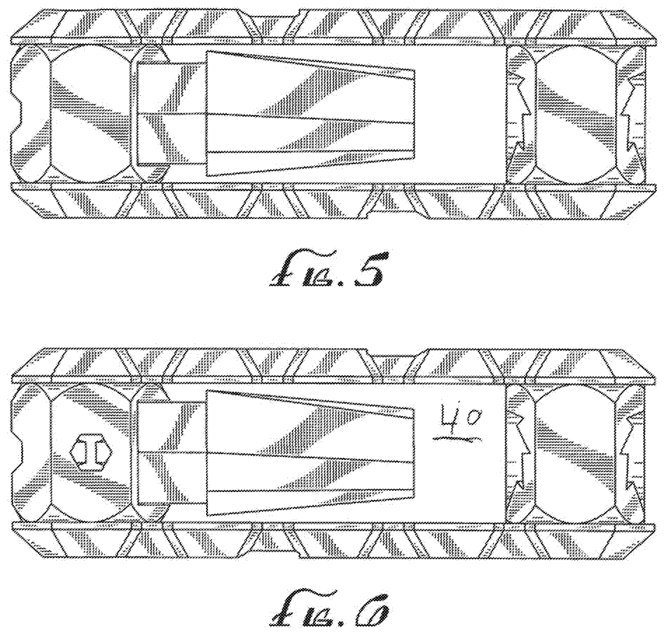

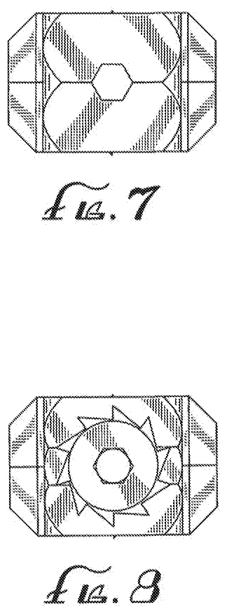

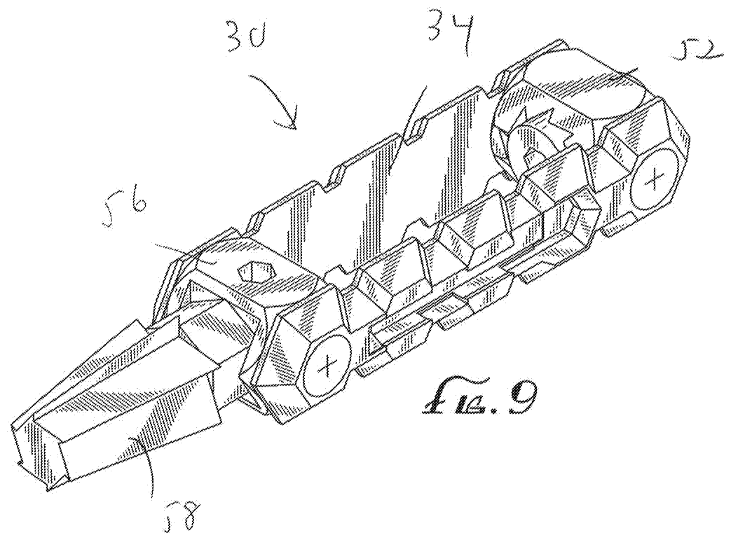

### DESCRIPTION

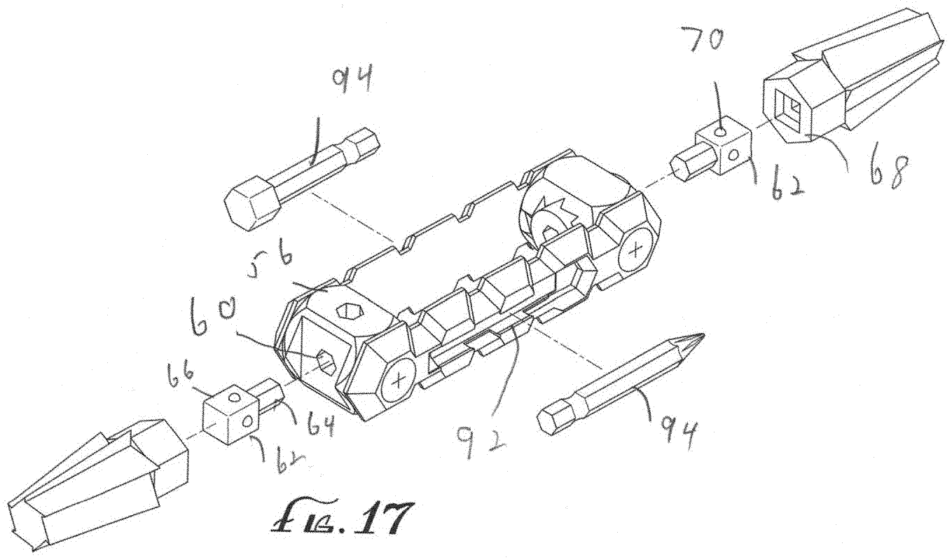

With reference to the drawings, a device 30 having features of the present invention comprises a body 32 having spaced apart, substantially parallel first and second side walls 34, each side wall 34 having an outer surface 36 and an inner surface 38, the two inner surfaces 38 facing each other. There is a slot 40 between the side walls 34. Each side wall 34 has a first end 44 and an opposed second end 46. A first holder system 48 is mounted between the first ends 44 of the side walls 34 and a second holder system 50 is mounted between the second ends 46 of the side walls 34. Both holder systems 48 and 50 can pivot at least 270 degrees on an axis 51 (FIG. 16) perpendicular to the plane of the side walls 34, and preferably can rotate 360 degrees.

The first holder system 50 comprises a first mount 52 for removably mounting a first tool, namely a first extractor 54 as shown in the figures, and the second holder system 50 comprises a second mount 56 for removably mounting a second tool, namely a second pipe extractor 58. Preferably the first 54 and second 58 extractors are different, such as having a different diameter, so that the device 30 can be used with pipes of different diameter for versatility.

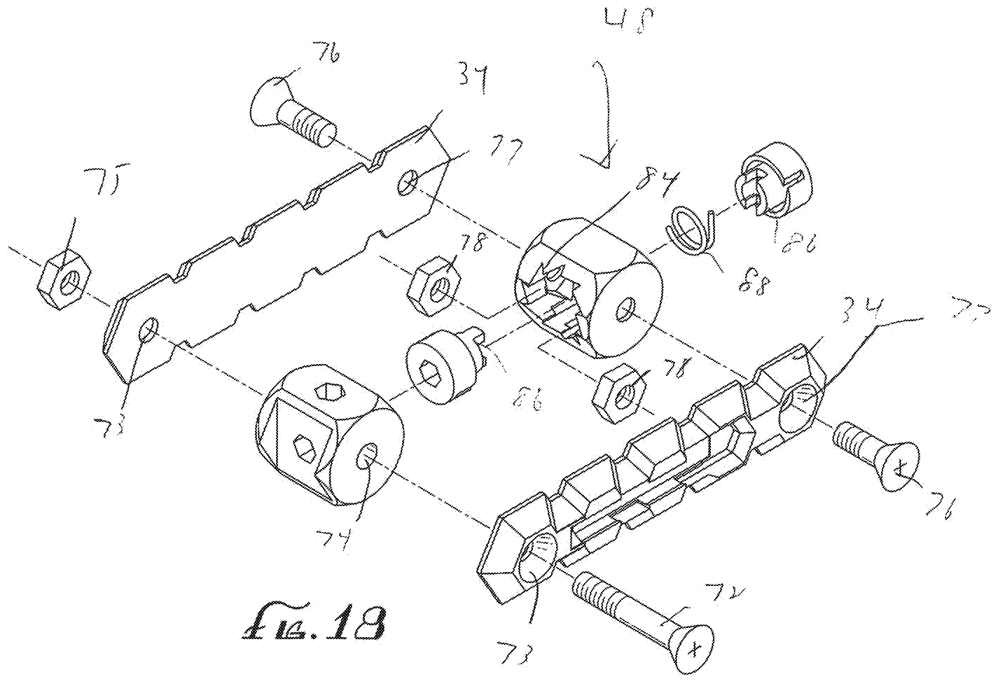

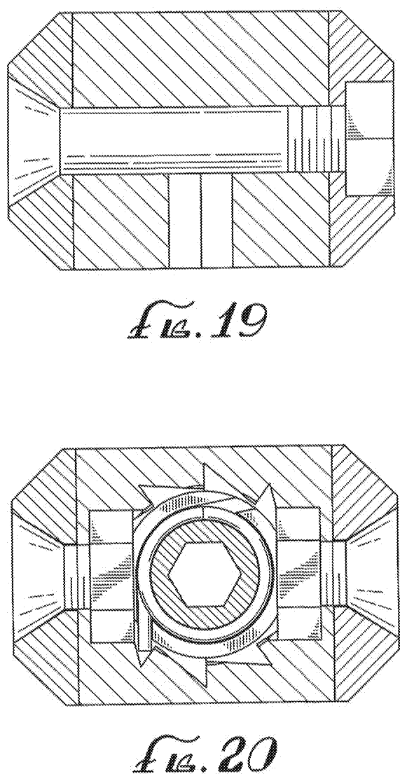

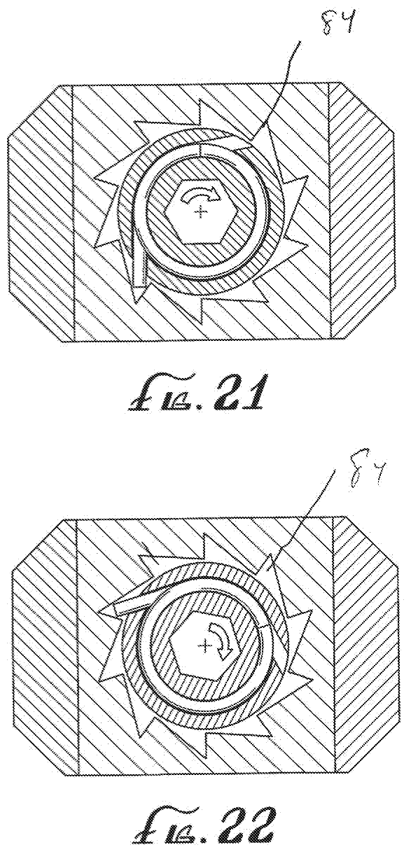

As shown in FIG. 17, each holder system 48 and 50 comprises one or more openings 60 in the respective mount 52, 56 in which a pin 62 is held. Each pin 62 comprises a first end section 64 which fits into the opening 60 and a second end section 66, which can be cubed shaped and on which one of the extractors fits, the extractor having a corresponding sized and shaped opening 68. The extractors are removably mounted on the respective pin 62. Each extractor or other tool can be held in place by projections 70 on a side wall of the pin second end section 66 with corresponding detents (not shown) on the extractor. The location of the detent and the projections can be reversed with the projections on the tool and the detents in the pin.

Preferably the outer surfaces 36 of the side walls 34 have grooves 71 or furrows or comparable structure for secure gripping by a user. The configuration of the grooves 71 shown in the figures is principally for decorative purposes.

As best shown in FIG. 18, the second mount 56 is rotatably fastened to the side walls 34 by a partially threaded fastener 72 that extends through aligned openings 73 through the side walls 34, and an aligned opening 74 through the second mount 56, and held in place by a nut 75. The first mount 52 is rotatably fastened in place by second threaded fasteners 76 that extend through respective aligned openings 77 in the side walls into aligned openings 78 in the first mount 52, utilizing nuts 78 holding each fastener 76 in place.

Preferably each holder system 48, 50 comprises a ratchet system so that each holder system 48, 50 system can rotate 360 degrees, but only in one direction. Each ratchet system 82 can comprise angled teeth 84 in each mount, with a pair of opposed pawls or cogs 86 that fit between the teeth 84, with a biasing spring 88 therebetween, the biasing spring exerting an outward force.

The device 20 can be made out of metal, or a strong plastic such as nylon, ABS, or polystyrene, or combinations of those materials.

Preferably one or both of the outer surfaces 36 of the side walls 34 has a longitudinally extending slot 92 in which can be held an auxiliary tool or implement 94, as best shown in FIG. 17. The implement can be a tool such as an awl or a screw driver head, optionally with an opening therein so it can removably be attached to one of the mounts 52, 54.

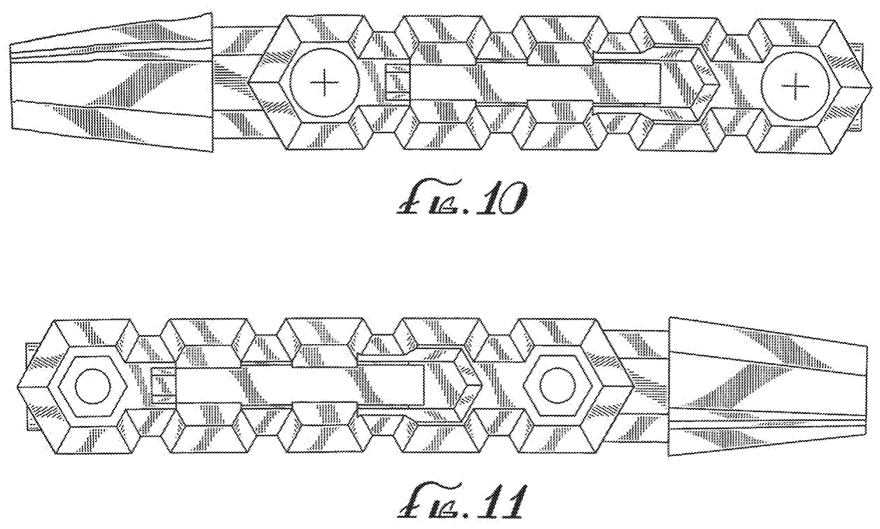

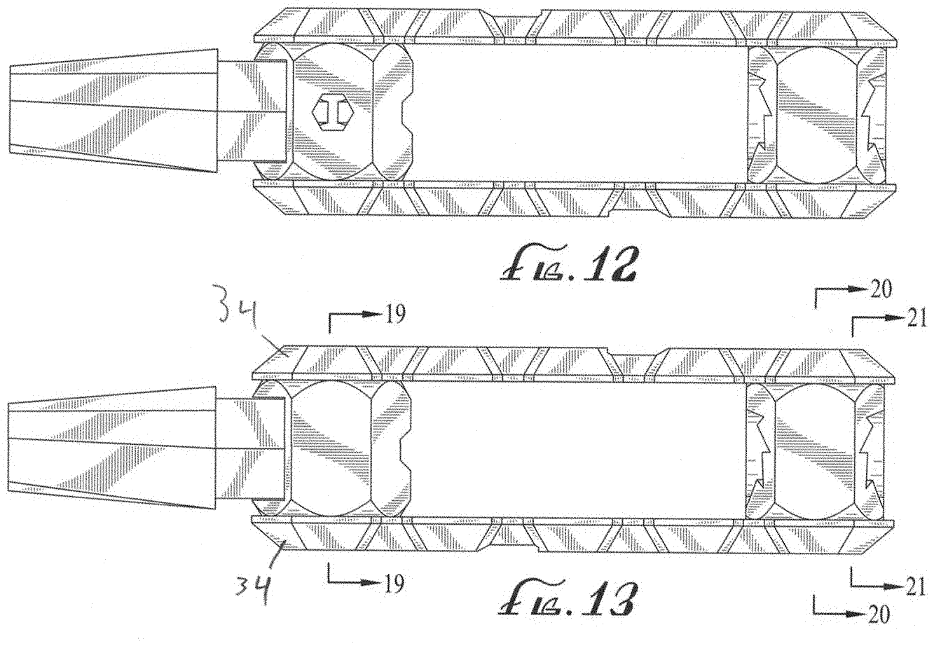

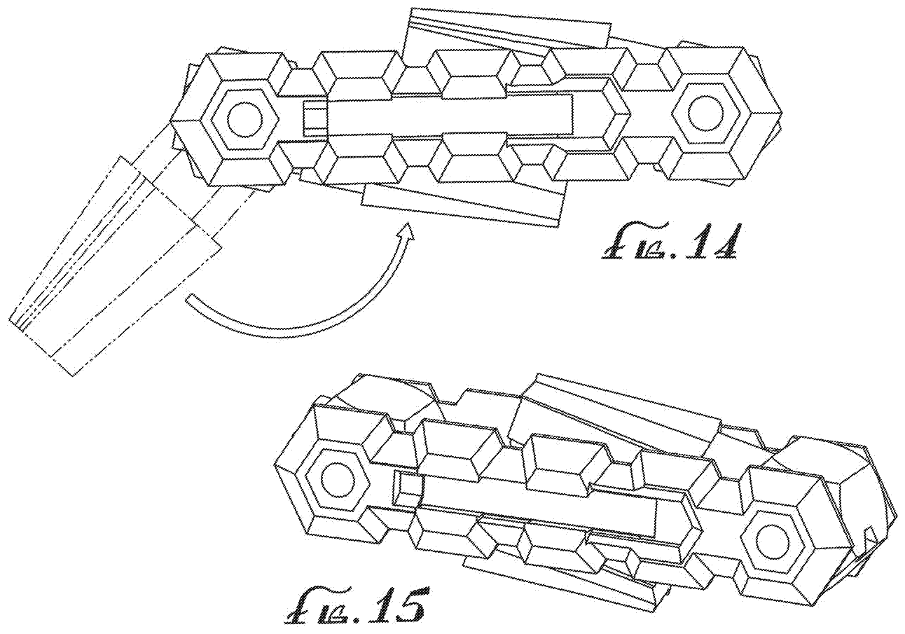

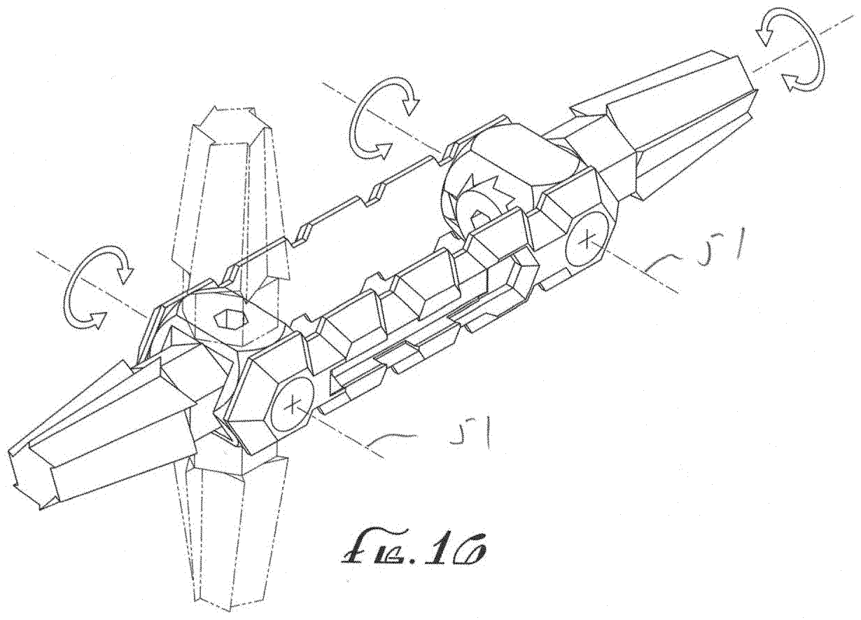

In use, a user holds the device 30, pivots one of the holder systems away from the slot 40 into a working position, such as shown in FIG. 9, uses the tool while in the working position, and then after using the tool pivots or rotates the holder back towards the slot so that the tool is at least partially in the slot. The slot is sized so that each tool, when mounted in place, can at least partially fit into the slot so that the device is easily transported; it can even be held in a pocket of the user.

Among the advantages of the present invention is the device is versatile in that different types of tools can be used, and when used with pipe extractors, different types of extractors can be used. Moreover, the tool can be pivoted to a desired working position for reaching difficult to access structures, such as broken pipes, that need to be worked on.

Although the present invention described in detailed with regard to preferred versions thereof, other versions are possible. For example, the device 30 could be used with tools other than extractors. One or both of the extractors can be replaced with a tool such as a screw driver head, a chisel head, a socket, or file. The mechanism used for holding a tool on one of the mounts need not be the same for both mounts. In addition, other holding systems other than a detent/mating projection can be used for holding a tool in place on the mount system, such as a compression fit, or threads that mate with a corresponding thread on the tool.

What is claimed is:

1. A device comprising:
a) a body having two opposed spaced apart, substantially parallel sidewalls, each sidewall having a first end, a second end and;
b) a slot between the sidewalls;
c) a first holder mounted between the sidewalls proximate the first ends, the first holder mounted to pivot at least 270 degrees on a first axis perpendicular to the planes of the sidewalls;
d) a second holder pivotally mounted between the sidewalls proximate to the second ends, the second holder mounted to pivot at least 270 degrees on a second axis perpendicular to the planes of the sidewalk;
e) a first mount supported by the first holder for removably mounting a first tool on the first holder; and
f) a second mount supported by the second holder for removably mounting a second tool on the second holder;
wherein the slot is sufficiently large the tools can be mounted on each respective mount with the tools being at least partially in the slot.

2. The device of claim 1 with the first tool on the first mount and a second tool on the second mount.

3. The device of claim 1 wherein each tool is a pipe extractor.

4. The device of claim 1 wherein the sidewalls have an interior surface and an exterior surface, and further comprising a recess in the exterior surface of at least one of the sidewalls for holding an implement.

5. The device of claim 1 wherein each mount comprises a pin extending from the respective holder.

6. The device of claim 3 wherein the extractors have different diameters.

7. The device of claim 1 wherein each mount can rotate 360 degrees, the device comprising a ratchet for each mount so each mount can rotate only in one direction.

8. A device comprising:
a) a body having two opposed spaced apart, substantially parallel sidewalls, each sidewall having a first end, a second end and;
b) a slot between the sidewalls;
c) a first holder mounted between the sidewalls proximate the first ends, the first holder mounted to rotate 360 degrees on a first axis perpendicular to the planes of the sidewalls;
d) a second holder pivotally mounted between the sidewalk proximate to the second ends, the second holder mounted to rotate 360 degrees on a second axis perpendicular to the planes of the sidewalls;
e) a first mount supported by the first holder, the first mount having a ratchet so the first mount can rotate only in one direction;
f) a first pipe extractor removably mounted on the first holder;
g) a second mount supported by the second holder, the second mount having a ratchet so the second mount can rotate only in one direction;
h) a second pipe extractor removably mounted on the first holder, the second pipe extractor having a diameter different than the diameter of the first pipe extractor;
i) wherein the slot is sufficiently large that the tools can be mounted on each respective mount with the tools being at least partially in the slot; and
j) wherein the sidewalk have an interior surface and an exterior surface, and further comprising a recess in the exterior surface of at least one of the sidewalls for holding an implement and an implement held in the recess.

9. A method comprising the steps of:
a. holding a device comprising:
i. a body having two opposed spaced apart sidewalls, each sidewall having a first end and a second end;
ii. a slot between the sidewalk;
iii. a first holder mounted between the sidewalls proximate the first ends, the first holder mounted to pivot at least 270 degrees on a first axis perpendicual to the plane of the sidewalls;
iv. a second holder pivotally mounted between the sidewalk proximate to the second ends, the second holder mounted to pivot at least 270 degrees on a second axis perpendicual to the planes of the sidewalls;
v. a first tool removably supported by the first holder; and
vi. a second tool removably supported by the second holder;
wherein the slot is sufficiently large that the tools are at least partially in the slot;
b. pivoting the first holder for pivoting the first tool away from the slot into a working position;
c. after step (h) using the first tool; and
d. after step (c) pivoting the first holder toward the slot so that the first tool is at least partially in the slot,

10. The method of claim 9 wherein step (d) comprises pivoting the first holder m the same direction it is pivoted in step (h).
